(19) United States
(12) Patent Application Publication
(10) Pub. No.: US 2024/0069705 A1
(43) Pub. Date: Feb. 29, 2024

(54) SCREEN MAGNIFICATION MOBILE APPLICATION DEVICE

(71) Applicant: Olivia Land, Chicago, IL (US)

(72) Inventor: Olivia Land, Chicago, IL (US)

(21) Appl. No.: 18/449,010

(22) Filed: Aug. 14, 2023

Related U.S. Application Data
(60) Provisional application No. 63/402,506, filed on Aug. 31, 2022.

(51) Int. Cl. G06F 3/04845; G06F 3/04847; G06F 9/451

(52) U.S. Cl. CPC G06F 3/04845; G06F 3/04847; G06F 9/453; G06F 2203/04806

(57) ABSTRACT

The device is preferably comprised of a mobile application interface with a prescription input, a vision chart, a blue light filter, and a night mode. The device allows a user to input their contact/eyeglasses prescription to proportionally increase or decrease the size of the content on the display of the smart device universally.

### CROSS-REFERENCE TO RELATED APPLICATION

The present application claims priority to, and the benefit of, U.S. Provisional Application No. 63/402,506, which was filed on Aug. 31, 2022, and is incorporated herein by reference in its entirety.

### FIELD OF THE INVENTION

The present invention relates generally to the field of smart devices. More specifically, the present invention relates to a screen magnification mobile application device. The device is preferably comprised of a mobile application interface with a prescription input, a vision chart, a blue light filter, and a night mode. The device allows a user to input their contact/eyeglasses prescription to proportionally increase or decrease the size of the content on the display of the smart device universally. Accordingly, the present disclosure makes specific reference thereto. Nonetheless, it is to be appreciated that aspects of the present invention are also equally applicable to other like applications, devices, and methods of manufacture.

### BACKGROUND

Many individuals need to wear contacts or glasses to see. However, wearing contacts or glasses while viewing display screens can increase eyestrain and fatigue. In addition, the displays of all smart devices emit blue light. Studies suggest that continued exposure to blue light over time could lead to damaged retinal cells which can lead to age-related macular degeneration. Further, looking at brightly lit screens at night disrupts the body's natural circadian rhythm and raises the risk of medical conditions linked to poor sleep, including obesity, heart disease, strokes, and depression.

Therefore, there exists a long-felt need in the art for a device that allows a user to view the display screen of a smart device clearly without the need for contacts or glasses. There also exists a long-felt need in the art for a screen magnification mobile application device that magnifies content on the display of a smart device to eliminate the need to use glasses or contacts. There also exists a long-felt need in the art for a screen magnification mobile application device that protects a user from blue light. Further, there exists a long-felt need in the art for a screen magnification mobile application device that protects a user from a brightly lit display at night.

The subject matter disclosed and claimed herein, in one embodiment thereof, comprises a screen magnification mobile application device. The device is preferably comprised of a mobile application interface with a prescription input, a vision chart, a blue light filter, and a night mode. The device allows a user to input their contacts/eyeglasses prescription to proportionally increase or decrease the size of content on the display of the smart device universally. The blue light filter also allows a user to limit the amount of blue light that can be viewed while observing the smart device display. The night mode further allows a user to automatically dim the smart device display during night hours.

In this manner, the screen magnification mobile application device of the present invention accomplishes all of the foregoing objectives and provides a device that allows a user to view the display screen of a smart device clearly without the need for contacts or glasses by magnifying content on the display of a smart device proportionally to a user's prescription. The device also protects a user from blue light. In addition, the device protects a user from a brightly lit display at night.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a screen magnification mobile application device. The device is preferably comprised of a mobile application interface with a prescription input, a vision chart, a blue light filter, and a night mode. The device may be in the form of a mobile application and/or software for a smart device such as a smartphone, a tablet, a computer, a television, etc.

A user can use at least one prescription input feature to upload their contact and/or glasses prescription into the device. The input feature has inputs for the left eye and right eye, wherein each input allows a user to input their prescription in diopter units with respect to the user's degree of farsightedness/nearsightedness and astigmatism. In one embodiment, the device may have a plurality of accounts (each with its own unique prescription input) that can be selected by a user of the smart device to allow multiple users with multiple prescriptions to use a singular smart device with the device.

The prescription input is also comprised of a vision chart that is preferably a Snellen chart with at least one indicia in the form of letters and/or numbers. Once a user inputs their prescription, the chart (and any indicia of the chart) will increase or decrease in size proportional to the strength of the prescription, such that the chart is no longer out of focus for the user when the user is not wearing eyeglasses or contacts while viewing the display of the smart device. Once the chart is of desired focus, the user can hit an apply feature that applies the level of magnification of the chart to the entire operating system of the smart device that the device is installed on.

The device is also comprised of a blue light filter that filters any blue light from the display of the smart device. The filter may have a plurality of filtering levels wherein the amount of blue light filtered can be selected by a slider. The device is also comprised of a night mode feature. The night mode feature automatically dims the display of the device from dusk to dawn or any other time range that can be selected via a slider during use of the device.

Accordingly, the screen magnification mobile application device of the present invention is particularly advantageous as it provides a screen magnification mobile application device that allows a user to view the display screen of a smart device clearly without the need for contacts or glasses by magnifying content on the display of a smart device proportionally to a user's prescription. The device also protects a user from blue light. Further, the device protects a user from a brightly lit display at night. In this manner, the screen magnification mobile application device overcomes the limitations of existing methods of using glasses/contacts to read the display of a smart device known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a login screen of one potential embodiment of a screen magnification mobile application device of the present invention in accordance with the disclosed architecture;

FIG. 2 illustrates a perspective view of a prescription input screen of one potential embodiment of a screen magnification mobile application device of the present invention in accordance with the disclosed architecture;

FIG. 3 illustrates a perspective view of a prescription viewing screen of one potential embodiment of a screen magnification mobile application device of the present invention in accordance with the disclosed architecture; and

FIG. 4 illustrates a flowchart of a method of using one potential embodiment of a screen magnification mobile application device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to view the display screen of a smart device clearly without the need for contacts or glasses. There also exists a long-felt need in the art for a screen magnification mobile application device that magnifies content on the display of a smart device to eliminate the need to use glasses or contacts. There also exists a long-felt need in the art for a screen magnification mobile application device that protects a user from blue light. Further, there exists a long-felt need in the art for a screen magnification mobile application device that protects a user from a brightly lit display at night.

The present invention, in one exemplary embodiment, is comprised of a screen magnification mobile application device. The device is preferably comprised of a mobile application interface with a prescription input, a vision chart, a blue light filter, and a night mode. The device may be in the form of a mobile application and/or software for a smart device such as a smartphone, a tablet, a computer, a television, etc.

A user can use at least one prescription input feature to upload their contact and/or glasses prescription into the device with respect to their left eye and right eye. Each input allows a user to input their prescription in diopter units with respect to the user's degree of farsightedness/nearsightedness and astigmatism. In one embodiment, the device may have a plurality of accounts (each with their own unique prescription input) that can be selected by a user of the smart device to allow multiple users with multiple prescriptions to use a singular smart device with the device.

The prescription input is also comprised of a vision chart. The chart is preferably a Snellen chart with at least one indicia in the form of letters and/or numbers. Once a user inputs their prescription, the chart (and any indicia of the chart) will increase or decrease in size proportional to the strength of the prescription such that the chart is no longer out of focus for the user when the user is not wearing eyeglasses or contacts when viewing the display of the smart device. Once the chart is of desired focus, the user can hit an apply feature that applies the level of magnification of the chart to the entire operating system of the smart device that the device is installed on.

The device is also comprised of a blue light filter. The blue light filter filters any blue light from the display of the smart device. The filter may have a plurality of filtering levels wherein the amount of blue light filtered can be selected by a slider. The device is also comprised of a night mode feature. The night mode feature automatically dims the display of the device from dusk to dawn or any other time range that can be selected via a slider during use of the device.

Accordingly, the screen magnification mobile application device of the present invention is particularly advantageous as it provides a screen magnification mobile application device that allows a user to via a display screen of a smart device clearly without the need for contacts or glasses by magnifying content on the display of a smart device proportionally to a user's prescription. The device also protects a user from blue light. Further, the device protects a user from a brightly lit display at night. In this manner, the screen magnification mobile application device overcomes the limitations of existing methods of using glasses/contacts to read the display of a smart device known in the art.

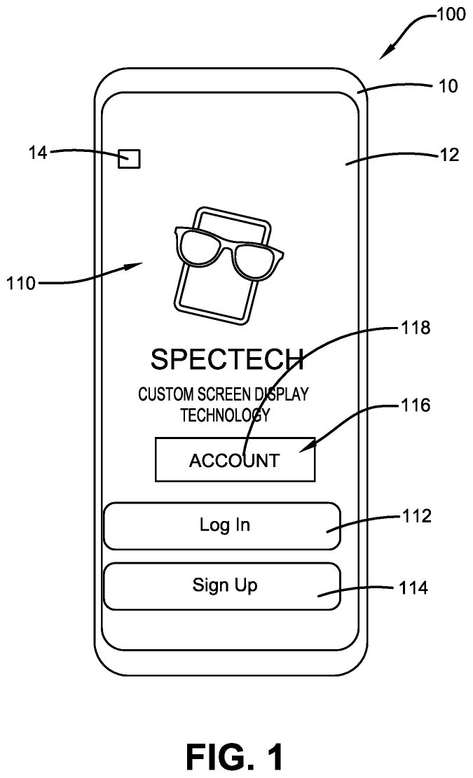

Referring initially to the drawings, FIG. 1 illustrates a perspective view of a login screen of one potential embodiment of a screen magnification mobile application device 100 of the present invention in accordance with the disclosed architecture. The device 100 is preferably comprised of a mobile application interface 110 with a prescription input 120, a vision chart 130, a blue light filter 150, and a night mode 160. The device 100 may be in the form of a mobile application and/or software for a smart device 10. A smart device 10 includes, but is not limited to, a smartphone, a tablet, a computer, a television, etc. The interface 110 is comprised of a signup feature 114 that allows a user to create an account 116 to use the device 100. Once an account 116 is created, a user can use the login 112 feature to log into the account 116 to use the device 100.

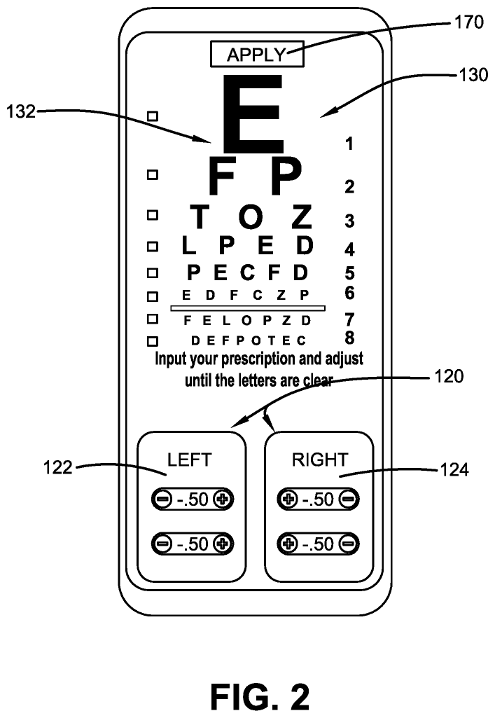

FIG. 2 illustrates a perspective view of a prescription input screen of one potential embodiment of a screen magnification mobile application device 100 of the present invention in accordance with the disclosed architecture. When creating their account 116, a user can use at least one prescription input 120 feature to upload their contact and/or glasses prescription. The input 120 has inputs for the left eye 122 and right eye 124, wherein each input 122,124 allows a user to input their prescription in diopter units. Each input 122,124 may allow a user to input their degree of farsightedness/nearsightedness and astigmatism in diopter units. In one embodiment, the device 100 may have a plurality of accounts 116 (each with their own unique prescription input 120) that can be selected by a user of the smart device 10. This allows multiple users with multiple prescriptions to use a singular smart device 10 with the device 100. Each account 116 may have at least one account identifier 118 such as, but not limited to, a username, a logo, an image, a prescription, etc.

The prescription input 120 is also comprised of a vision chart 130. The vision chart 130 is preferably a Snellen chart with at least one indicia 132. The indicia 132 is preferably, but not limited to, the form of letters and/or numbers. Once a user inputs their prescription, the chart 130 (and any indicia 132 of the chart 130) will magnify or reduce in size proportional to the strength of the prescription, such that the chart 130 is no longer out of focus for the user when the user is not wearing eyeglasses or contacts when viewing the display 12 of the smart device 100. If still out of focus, a user can increase or decrease the prescription input 120 as needed to adjust the size of the chart 130.

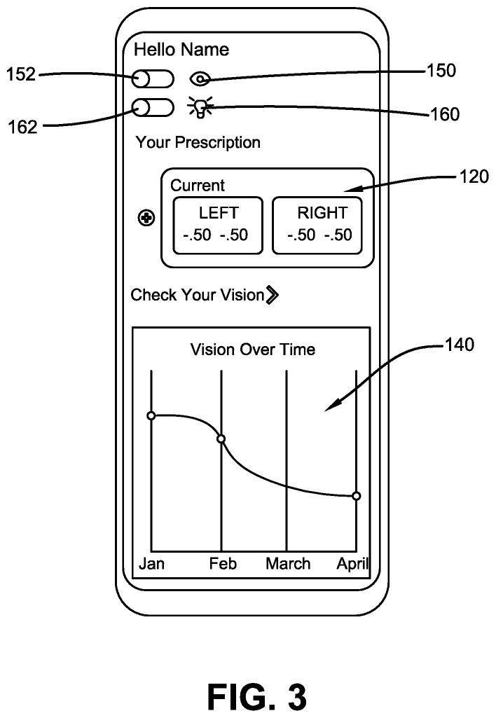

FIG. 3 illustrates a perspective view of a prescription viewing screen of one potential embodiment of a screen magnification mobile application device 100 of the present invention in accordance with the disclosed architecture. Any changes in the prescription input 120 can be displayed over time with at least one prescription display 140 which may be in the form of a chart, a list, etc. Once the chart 130 is of desired focus, the user can hit an apply feature 170 that applies the level of magnification of the chart 130 to the entire operating system 14 of the smart device 10 that the device 100 is installed on.

The device 100 is also comprised of a blue light filter 150 that filters any blue light from the display 12 of the smart device 10. In one embodiment, the filter 150 may have a plurality of filtering levels wherein the amount of blue light filtered can be selected by a slider 152.

The device 100 is also comprised of a night mode 160 feature. The night mode 160 feature automatically dims the display 12 of the device 100 from dusk to dawn or any other time range that can be selected via a slider 160 during use of the device 10.

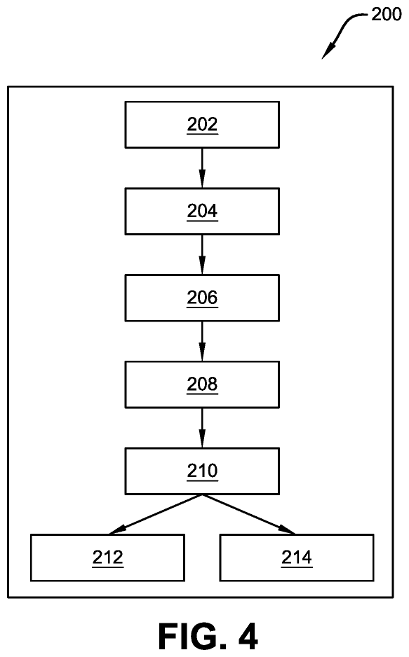

FIG. 4 illustrates a flowchart of a method 200 of using one potential embodiment of a screen magnification mobile application device 100 of the present invention in accordance with the disclosed architecture. The device 100 is also comprised of a method of use 200. First, the user downloads the device 100 onto a smart device 10 [Step 202]. Then, the user creates an account 116 by inputting their eyeglasses or contacts prescription for their left eye 122 and right eye 124 [Step 204]. The user then views the vision chart 130 to ensure the indicia 132 on the chart is in focus [Step 206]. If not in focus, a user can adjust the prescriptions 122,124 as needed within the device [Step 208]. Then, the degree of magnification or reduction of the chart 130 proportional to the prescriptions 122,124 can be applied to an entire operating system 14 and visual display 12 of the smart device 10 [Step 210]. A user can also activate and adjust a blue light filter 150 [Step 212]. In addition, a user can activate and adjust a night mode 160 [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “screen magnification mobile application device” and “device” are interchangeable and refer to the screen magnification mobile application device 100 of the present invention.

Notwithstanding the foregoing, the screen magnification mobile application device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the screen magnification mobile application device 100 as shown in the FIGS. are for illustrative purposes only, and that many other sizes and shapes of the screen magnification mobile application device 100 are well within the scope of the present disclosure. Although the dimensions of the screen magnification mobile application device 100 are important design parameters for user convenience, the screen magnification mobile application device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A screen magnification mobile application device comprising:
an interface;
an account;
a prescription input;
a vision chart;
a blue light filter; and
a night mode.

2. The screen magnification mobile application device of claim 1, wherein the prescription input is comprised of a contact prescription or a glasses prescription.

3. The screen magnification mobile application device of claim 2, wherein the vision chart is magnified a first amount or reduced a second amount proportionally with respect to the contact prescription or the glasses prescription.

4. The screen magnification mobile application device of claim 3, wherein the first amount of magnification or the second amount of reduction is applied to an entire operating system of a smart device that the screen magnification mobile application device is installed on.

5. A screen magnification mobile application device comprising:
an interface;
an account;
a prescription input comprised of a left eye prescription and a right eye prescription;
a vision chart comprised of an indicia;
a blue light filter; and
a night mode.

6. The screen magnification mobile application device of claim 5, wherein each of the left eye prescription and the right eye prescription is comprised of a diopter unit.

7. The screen magnification mobile application device of claim 5, wherein the vision chart is comprised of a Snellen chart.

8. A screen magnification mobile application device comprising:
an interface;
an account;
a prescription display;
a prescription input comprised of a left eye prescription and a right eye prescription;
a vision chart comprised of an indicia;
a blue light filter comprised of a slider; and
a night mode comprised of a slider.

9. The screen magnification mobile application device of claim 8, wherein the indicia is a word or a number.

10. The screen magnification mobile application device of claim 8, wherein the prescription display is comprised of a graph.

11. The screen magnification mobile application device of claim 10, wherein the prescription displays illustrate a change in the prescription input over a time.

12. The screen magnification mobile application device of claim 8, wherein an amount of blue light filtered by the blue light filter can be adjusted by the slider.

13. The screen magnification mobile application device of claim 8, wherein the night mode automatically dims a brightness level of a smart device that the screen magnification mobile application device is installed on from a dusk to dawn time period.

14. The screen magnification mobile application device of claim 13, wherein the amount of dimming can be adjusted by the slider.

15. The screen magnification mobile application device of claim 8, wherein the prescription input is unique to the account.

16. The screen magnification mobile application device of claim 8, wherein the account is comprised of an account identifier.

17. The screen magnification mobile application device of claim 8, wherein the left eye prescription is comprised of a degree of farsightedness or a degree of nearsightedness and a degree of astigmatism.

18. The screen magnification mobile application device of claim 8, wherein the right eye prescription is comprised of a degree of farsightedness or a degree of nearsightedness and a degree of astigmatism.

19. The screen magnification mobile application device of claim 8, wherein the vision chart is magnified a first amount or reduced a second amount proportionally with respect to the contact prescription or the glasses prescription.

20. The screen magnification mobile application device of claim 19, wherein the first amount of magnification or the second amount of reduction is applied to an entire operating system of a smart device that the screen magnification mobile application device is installed on.
